(19) United States
(12) Patent Application Publication
(10) Pub. No.: US 2004/0168999 A1
(43) Pub. Date: Sep. 2, 2004

(54) Tamper evident closure with locking band and container therefor

(76) Inventor: Thomas M. Seidita, Mechanicsville, VA (US)

Correspondence Address: KNOBLE YOSHIDA & DUNLEAVY, LLC, Eight Penn Center, Suite 1350, 1628 John F. Kennedy Blvd., Philadelphia, PA, 19103, US

(21) Appl. No.: 10/771,614

(22) Filed: Feb. 4, 2004

Related U.S. Application Data
(63) Continuation-in-part of application No. 10/241,416, filed on Sep. 11, 2002.

(51) Int. Cl. B65B 7/28; A61J 1/03; B65D 55/02

(52) U.S. Cl. 215/44; 215/201

(57) ABSTRACT

A container assembly includes a container that has an externally threaded finish portion as well as retention structure for preventing upward movement of a tamper evident band. The container assembly further includes a closure having a body portion of a base and an internally threaded downwardly depending sidewall portion that is sized and shaped to screw onto the finish portion of the container. The closure further includes a tamper evident band that is frangibly connected to the sidewall portion and that includes a main band portion and a J-hook retention member. The J-hook retention member includes a plurality of pleated retaining elements, each of which has upper portion for engaging the retention structure. Advantageously, at least one of the pleated retaining elements is further constructed and arranged to engage the container so as to resist rotation with respect to the container, whereby separation of said tamper evident band from said body portion is better assured when the closure is unscrewed from the container.

This is a continuation-in-part of Ser. No. 10/241,416, filed Sep. 11, 2002, the entire disclosure of which is hereby incorporated as if set forth fully herein.

### BACKGROUND OF THE INVENTION

1. Field of the Invention

This invention relates generally to the field of packaging technology, and more specifically to tamper evident closures for containers.

2. Description of the Related Technology

Various beverages, foods, medicines and the like are delivered to the public in bottles or other containers that are provided with resealable closures. Such closures provide a benefit to the consumer in that the containers can be tightly sealed and resealed after opening, which prolongs the shelf life of the product and maintains freshness. Although resealable containers provide benefits to consumers, by their nature they permit unauthorized and sometimes undetectable tampering with the product. Accordingly, many modern consumer products are packaged using tamper evident closures, which are designed to make it apparent to a consumer that a container has been opened.

Many conventional tamper evident closures utilize what is commonly known as a tamper evident band, which is designed to be retained by the container and to rupture or become separated from the consumer removable portion of the closure during opening. Typically, the container itself will include an annular ring or other retention structure for engaging the tamper evident band. The tamper evident band and the mating retention structure of the container are usually designed so that the tamper evident band will slip over the retention structure without damage during the initial application of the closure onto the container at the packaging plant, but that subsequent removal of the tamper evident band from the container will be difficult.

One type of tamper evident band that is in commercial use includes a first portion that is frangibly connected to the consumer removable portion of the closure and a second retention portion, commonly known as a J-hook, that is molded so as to angle radially inwardly and upwardly from a lower portion of the tamper evident band in order to engage retention structure on the container. During initial application of the closure, the retention portion will slip over the retention structure because of the inward and upward angling, but once it slips over the retention structure it will lock against the lower side of the retention structure, making it difficult to remove the tamper evident band from the container. An example of such a closure is disclosed in U.S. Pat. No. 5,400,913 to Kelly. Such closures are valued for their strength and ease of application.

Unfortunately, because of the inherent elasticity of some types of plastic materials, particularly at elevated temperatures, it is possible in some instances for a closure to be removed from the container with the tamper evident band still joined to the closure. Although, it is to be emphasized, this is a relatively rare occurrence, it is to be taken seriously as it frustrates the fundamental purpose of a tamper evident closure.

Other types of closures have been developed that ensure separation of the tamper evident band from the closure during opening by arresting rotational movement of the tamper evident band with respect to the closure during opening. One example of this would be U.S. Pat. No. 5,040,692 to Julian, which discloses a tamper indicating closure in which ratchet teeth are molded into the tamper evident band. These teeth engage similar projections that are molded beneath the finish portion of a container to which the closure is applied. While closures of this type are no doubt effective, they require the molding of a relatively thick tamper evident band, which increases material costs. Accordingly, for some applications that are more sensitive to material costs it would be economically difficult to apply such technology. Moreover, it is not possible to apply structure of the type that is taught in Julian for use in a closure that utilizes a J-hook type retention structure for the tamper evident band.

A need exists for an improved J-hook type retention structure for a tamper evident band that reduces the likelihood of the closure being unscrewed from a container without separation of the tamper evident band from the rest of the closure.

### SUMMARY OF THE INVENTION

Accordingly, it is an object of the invention to provide an improved J-hook type retention structure for a tamper evident band that reduces the likelihood of the closure being unscrewed from a container without separation of the tamper evident band from the rest of the closure.

In order to achieve the above and other objects of the invention, a tamper evident closure according to a first aspect of the invention includes a body portion having a base and an internally threaded downwardly depending sidewall portion; and a tamper evident band frangibly connected to the sidewall portion, the tamper evident band including a main band portion, and a J-hook retention member that includes a plurality of pleated retaining elements, and wherein each of the retaining elements has an upper portion that is constructed and arranged to engage retention structure of a container in order to prevent upward movement of the tamper evident band with respect to the container, and wherein at least one of the pleated retaining elements is further constructed and arranged to engage the container so as to resist rotation with respect to the container, whereby separation of the tamper evident band from said body portion is better assured when the closure is unscrewed from the container.

According to a second aspect of the invention, a container assembly includes a container having an externally threaded finish portion that has retention structure for retaining a tamper evident band; a closure comprising a body portion having a base and an internally threaded downwardly depending sidewall portion, the closure further comprising a tamper evident band that is frangibly connected to the sidewall portion, and wherein the tamper evident band includes: a main band portion, and a J-hook retention member that includes a plurality of pleated retaining elements, and wherein each of the retaining elements has an upper portion that is constructed and arranged to engage the retention structure in order to prevent upward movement of the tamper evident band with respect to the container, and wherein at least one of the pleated retaining elements is further constructed and arranged to engage the container so as to resist rotation with respect to the container, whereby separation of the tamper evident band from the body portion is better assured when the closure is unscrewed from the container.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a fragmentary side elevational view of a container that is constructed according to a preferred embodiment of the invention;

FIG. 2 is a cross-sectional view taken along lines 2-2 in FIG. 1;

FIG. 3 is a magnified view of an area in FIGURE to that is indicated by lines 3-3 in FIG. 2;

FIG. 4 is a bottom plan view of a closure according to the preferred embodiment of the invention; and

FIG. 5 is a partially diagrammatical, partially cross-sectional view depicting features of the closure that is depicted in FIG. 4.

### DETAILED DESCRIPTION OF THE PREFERRED EMBODIMENT(S)

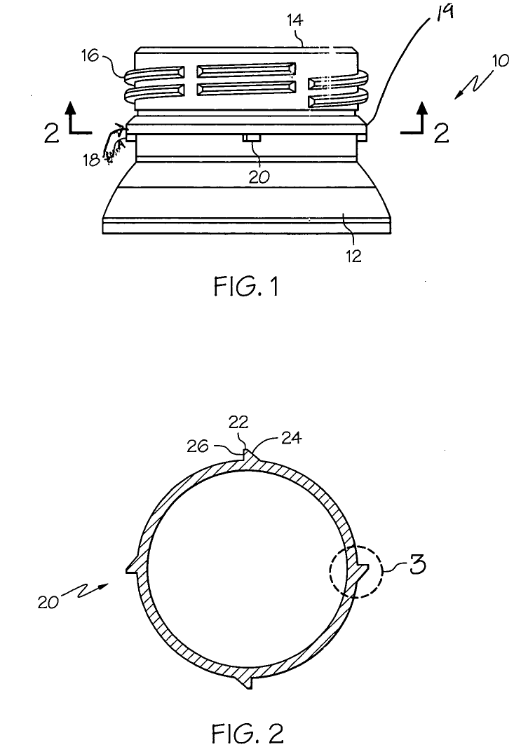

Referring now to the drawings, wherein like reference numerals designate corresponding structure throughout the views, and referring in particular to FIG. 1, a container assembly 10 that is constructed according to the preferred embodiment of the invention includes a container 12 having a finish portion 14 that is molded with external threads 16. As is conventional, finish portion 14 is provided with retention structure 18 for retaining a tamper evident band by limiting upward movement of the tamper evident band after a closure has been applied to the finish portion 14 of the container assembly 10. In the illustrated embodiment, retention structure 18 is a radially outwardly projecting continuous annular ring 19.

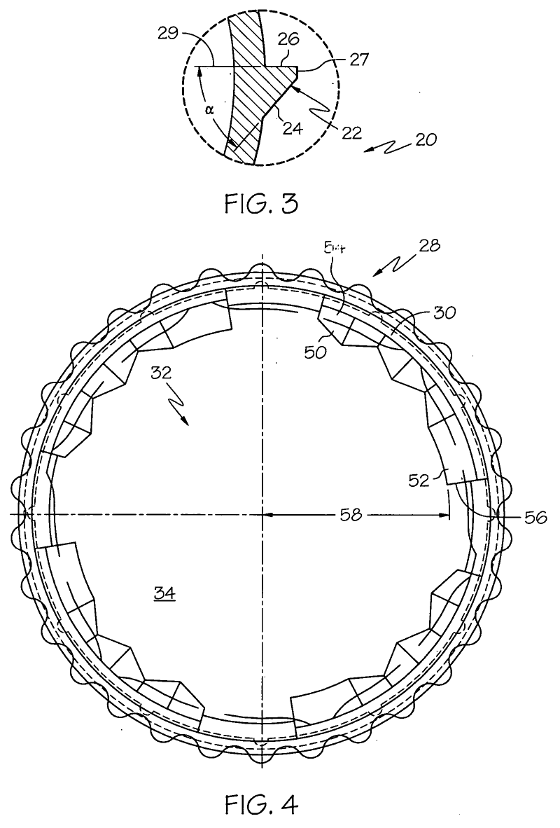

As may further be seen in FIG. 1, container 12 further includes rotational locking structure that is constructed and arranged so as to arrest rotation of the tamper evident band with respect to the container 12, as will be described in appropriate detail below. Referring now to FIGS. 2 and 3, it will be seen that the rotational locking structure 20 is preferably embodied as four ratchet teeth 22, which are spaced about the circumference of the lower part of the finish portion 14, beneath the retention structure 18, at 90 degree intervals. As may best be seen in FIG. 3, each ratchet tooth 22 includes a ramped leading edge 24, which is angled with respect to a radius 29 of the finish portion 14 at an angle α so as to guide a tamper evident band such as the tamper evident band 38 described herein thereover during the initial application of a closure to the finish portion 14 of the container assembly 10. Each ratchet tooth 22 further includes a flat trailing edge 26 that is preferably flat and terminates in an edge 27 so as to arrest movement of the tamper evident band 38 in an unscrewing direction after the closure has been applied to the finish portion. As may be seen in FIG. 3, flat trailing edge 26 is preferably parallel to a radius 29 of the finish portion 14.

Preferably, the rotational locking structure is positioned so as to be at least substantially adjacent to the retention structure 18. At least substantially adjacent is defined as being positioned within a distance of no more than about 0.25 inches from the retention structure 18. In the more preferred embodiment, the rotational locking structure is preferably molded so as to be unitary with a lower surface of the radially outwardly projecting continuous annular ring 19.

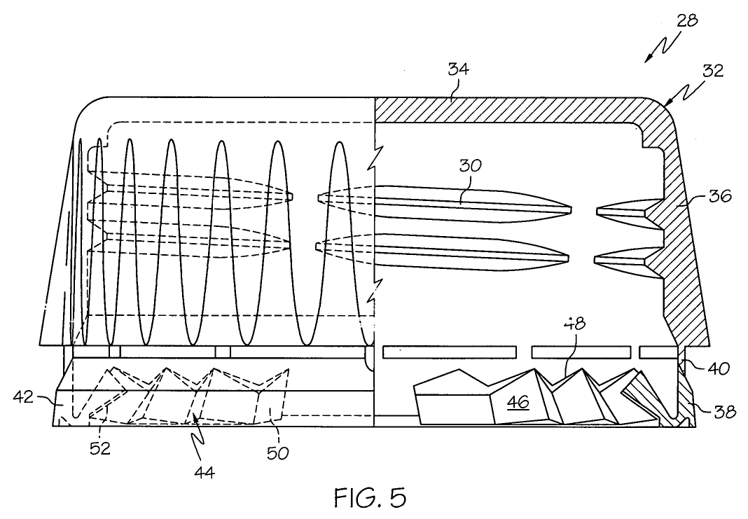

Referring now to FIGS. 4 and 5, it will be seen that container assembly 10 further includes a closure 28 having a body portion 32 with a base 34 and a downwardly depending annular sidewall portion 36 that has internal threading 30 defined thereon. Closure 28 further includes a tamper evident band 38 that is frangibly connected to the sidewall portion 36 by a plurality of breakable bridges 40, as is well known in this area of technology. Tamper evident band 38 includes, as is best shown in FIG. 5, a main band portion 42 and a J-hook retention member 44 that includes a plurality of pleated retaining elements 46. Each of the pleated retaining elements 46 has an upper portion 48 that is constructed and arranged to engage the retention structure 18 of the container 12 in order to prevent upward movement of the tamper evident band 38 with respect to the container 12 after the closure 28 has been applied to the container 12.

According to one important aspect of the invention, at least one of the pleated retaining elements 46 is further constructed and arranged to engage the container 12 so as to resist rotation with respect to the container 12. Accordingly, separation of the tamper evident band 38 from the body portion 32 is better assured when the closure 28 is unscrewed from the container 12. More specifically, in the preferred embodiment there are four of the retaining elements 46, and each is configured so as to have a leading edge 50, best shown in FIG. 4, that is shaped so as to permit the retaining elements 46 to pass over the rotational locking structure 20 on the container 12 when the closure 28 is first applied to the container 12. As may be seen in FIG. 4, each of the leading edge is 50 include a ramped surface 54 that are ramped radially inwardly in a direction corresponding to an application motion of the closure 28 onto the container 12. Conversely, each of the retaining elements 46 also includes a trailing edge 52 that is shaped so as to firmly engage the rotational locking structure 20 when the closure 28 is being unscrewed from the container 12. As may be seen in FIG. 4, trailing edge 52 is positioned radially inwardly from the leading edge 50, and is characterized by a flat abutment surface 56 that is oriented so as to be within a plane that is substantially parallel to a radius 58 of the closure 28. Abutment surface 56 will, upon any attempt to unscrew the closure 28 from the container 12, firmly engage against the flat trailing surface 26 of the rotational locking structure 20, thereby ensuring rupture of the bridges 40 and separation of the tamper evident band 38 from the main body portion 32 of the closure 28 before any significant rotational displacement occurs between the closure 28 and the container 12.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A container, comprising:
a main body portion; and
a finish portion, said finish portion comprising
at least one external thread that is constructed and arranged to facilitate attachment of a closure to said container;
radially extending retention structure positioned beneath said external thread; and
rotational locking structure, positioned so as to be at least substantially adjacent to said retention structure, for arresting rotation of a tamper evident band on a closure relative to said container in at least one direction.

2. A container according to claim 1, wherein said radially extending retention structure comprises an annular ring that is unitary with said finish portion, said annular ring protruding radially outwardly from said finish portion.

3. A container according to claim 2, wherein said rotational locking structure is unitary with said annular ring.

4. A container according to claim 1, wherein said rotational locking structure is unitary with said radially extending retention structure.

5. A container according to claim 4, wherein said rotational locking structure is unitary with a lower surface of said radially extending retention structure.

6. A container according to claim 1, wherein said rotational locking structure comprises a plurality of ratcheted teeth.

7. A container according to claim 6, wherein each of said ratcheted teeth comprises a ramped leading surface and a relatively flat trailing surface.

8. A container according to claim 6, wherein said rotational locking structure comprises at least three of said ratcheted teeth.

9. A container according to claim 8, wherein said rotational locking structure comprises at least four of said ratcheted teeth.
